(19) United States
(12) Patent Application Publication
(10) Pub. No.: US 2019/0293145 A1
(43) Pub. Date: Sep. 26, 2019

(54) Cylinder-End-Cap

(71) Applicant: ZF Friedrichshafen AG, Friedrichshafen (DE)

(72) Inventors: Robert HENNEBERG, Gochsheim (DE); Björn SCHULZ, Bonn (DE)

(73) Assignee: ZF Friedrichshafen AG

(21) Appl. No.: 16/353,319

(22) Filed: Mar. 14, 2019

(30) Foreign Application Priority Data
Mar. 23, 2018 (DE) 10 2018 204 478.3

(51) Int. Cl. F16F 9/38; B60G 13/06

(52) U.S. Cl. CPC F16F 9/38; B60G 2202/24; B60G 2206/41; B60G 13/06

(57) ABSTRACT

A pressure stop cap for a motor vehicle vibration damper includes a disk-shaped end portion which is formed in an end area of the pressure stop cap and forms a rebound surface for an impact absorber, a tubular portion extending axially from the disk-shaped end portion, and at least one vent opening which is arranged adjacent to the end portion in the end area of the pressure stop cap and extends radially through the tubular portion. The pressure stop cap has a groove-like circumferential recess which is formed at its outer surface and which divides the outer surface of the pressure stop cap axially into a first pressure stop cap portion and a second pressure stop portion, the first pressure stop cap portion being formed in the area of the end portion. The cross section of the first pressure stop cap portion is larger than the cross section of the pressure stop cap in the area of the circumferential recess, and the cross section of the second pressure stop cap portion is larger than the cross section of the pressure stop cap in the area of the circumferential recess.

### FIELD OF THE INVENTION

The present invention is directed to a pressure stop cap for a motor vehicle vibration damper and to a motor vehicle vibration damper having this pressure stop cap.

### BACKGROUND OF THE INVENTION

A pressure stop cap for a motor vehicle vibration damper is well known. For example, DE 10 2009 025 142 A1, the entire content of which is hereby incorporated by reference, shows a generic pressure stop cap which comprises a disk-shaped portion formed in an end area of the pressure stop cap and a tubular portion extending axially from the disk-shaped portion. Further, the pressure stop cap according to DE 10 2009 025 142 A1 has a plurality of vent openings which are arranged in the end area of the pressure stop cap and extend radially through the hollow cylindrical portion. Further, the pressure stop cap has a rib structure formed at its outer circumference.

A motor vehicle vibration damper has the object of damping shocks excited by uneven road surfaces. The shocks excited by unevenness in the road are transmitted by design to the piston rod which moves axially and partially dips into and slides out of the cylinder tube so as to be sealed from the environment by a piston rod seal. In some, usually extreme, driving situations such as, for example, when driving over very uneven terrain, it may come about that the piston rod is pushed into the cylinder tube of the motor vehicle vibration damper at high velocity. To prevent destruction of the damper, an impact absorber is usually used which is fixed at least indirectly to the piston rod and rebounds against a pressure stop cap arranged at the cylinder tube of the motor vehicle vibration damper and brakes the axial movement of the piston rod. The vent openings formed at the pressure stop cap allow the passage of the air volume which is displaced and sucked in again by the impact absorber landing on and lifting off from the disk-shaped portion of the pressure stop cap. A protective tube whose task it is to keep dirt away from the piston rod seal moves over the cap.

Since the protective tube causes a pumping effect, it cannot be ruled out that fine dirt is sucked in between the pressure stop cap and the protective tube while the protective tube effectively keeps coarser dirt away.

This fine dirt can accordingly be sucked into the area below the cap through the vent openings, damage the piston rod seal and accordingly lead to failure of the motor vehicle vibration damper.

When the pressure stop cap has a rib structure formed at its outer circumference as is shown in DE 10 2009 025 142 A1, this could make it easier for dirt to be sucked in because the ribs would channel the air flow directly to the vent openings.

### SUMMARY OF THE INVENTION

Therefore, an object of the present invention is to provide a pressure stop cap for a motor vehicle vibration damper which overcomes the disadvantages of the prior art and prevents dirt from reaching the piston rod seal of the motor vehicle vibration damper.

This object is met in that the pressure stop cap has a groove-like circumferential recess which is formed at its outer surface and which divides the outer surface of the pressure stop cap axially into a first pressure stop cap portion and a second pressure stop portion. The first pressure stop cap portion is formed in the area of the end portion, and the cross section of the first pressure stop cap portion is larger than the cross section of the pressure stop cap in the area of the circumferential recess, and the cross section of the second pressure stop cap portion is larger than the cross section of the pressure stop cap in the area of the circumferential recess.

In this way, the route along which the dirt flows is interrupted through the circumferential recess so that the penetration of dirt under the cap and, accordingly, into the seal is drastically reduced or entirely prevented.

Moreover, the circumferential recess provides a circumferential rebound surface by the projecting lid of the cap. The air flow is reflected and additionally whirled at this surface so that dust particles are additionally hindered from reaching the piston rod seal through the vent openings.

According to an advantageous constructional embodiment, the circumferential groove-like recess can be arranged axially below the area of the vent opening. This embodiment is advantageous above all when using the vibration damper in a location with high dust exposure because, as a result of this position of the circumferential recess, the above-mentioned whirling effect prevents the dust particles from reaching the piston rod seal through the vent opening.

When the motor vehicle vibration damper is provided primarily for use in areas exposed to dirty water, it is advantageous when the circumferential groove-like recess is arranged in the area of the vent opening because the first pressure stop cap portion has a larger cross section than the cross section of the pressure stop cap in the area of the circumferential recess and accordingly forms a drip edge which prevents the dirty water from reaching the piston rod seal through the vent opening.

When the pressure stop cap comprises a plurality of axially extending ribs arranged at the upper surface of the pressure stop cap, the axial extension of the ribs is advantageously axially limited through the circumferential recess on the one side and through the length of the pressure stop cap on the other side. This prevents the ribs from channeling the air flow directly to the vent opening.

### BRIEF DESCRIPTION OF THE DRAWINGS

The invention will now be described in more detail according to the following figures, in which:

FIG. 1 is a sectional view of a motor vehicle vibration damper according to the prior art;

FIG. 2 is a side view of a pressure stop cap according to the prior art;

FIG. 3 is a sectional view of a first exemplary constructional embodiment of a pressure stop cap according to the invention;

FIG. 4 is a sectional view of a second exemplary constructional embodiment of a pressure stop cap according to the invention; and

FIG. 5 is a third exemplary constructional embodiment of a pressure stop cap according to the invention.

### DETAILED DESCRIPTION OF THE PRESENTLY PREFERRED EMBODIMENTS

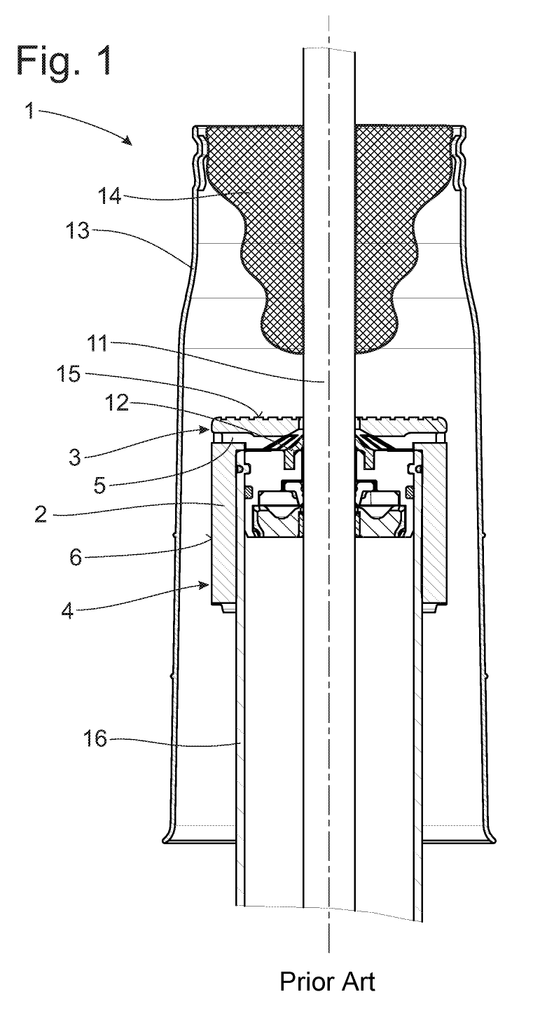

FIG. 1 shows a generic motor vehicle vibration damper 1 according to the prior art. It comprises a pressure stop cap 2 and a piston rod 11 which is partially guided into a damper cylinder 16 and which is sealed by a piston rod seal 12. The piston rod 11 and a portion of the damper cylinder 16 are protected by a protective tube 13 which surrounds the latter so as to include an annular gap in circumferential direction.

An impact absorber 14 is arranged at the upper end of the protective tube 13 referring to FIG. 1. The impact absorber 14 comes in contact with a rebound surface 15 in case of an inward movement of the piston rod 11 into the damper cylinder 16. The disk-shaped rebound surface 15 is formed at the end portion 3 of the pressure stop cap 2, this end portion 3 being arranged on the impact absorber side.

A tubular portion 4 of the pressure stop cap 2 which extends around the damper cylinder 16 in circumferential direction extends axially proceeding from the disk-shaped end portion 3 of the pressure stop cap 2.

A plurality of vent openings 5 are arranged adjacent to the end portion 3 in the end area of the pressure stop cap 2 and extend radially through the tubular portion 4.

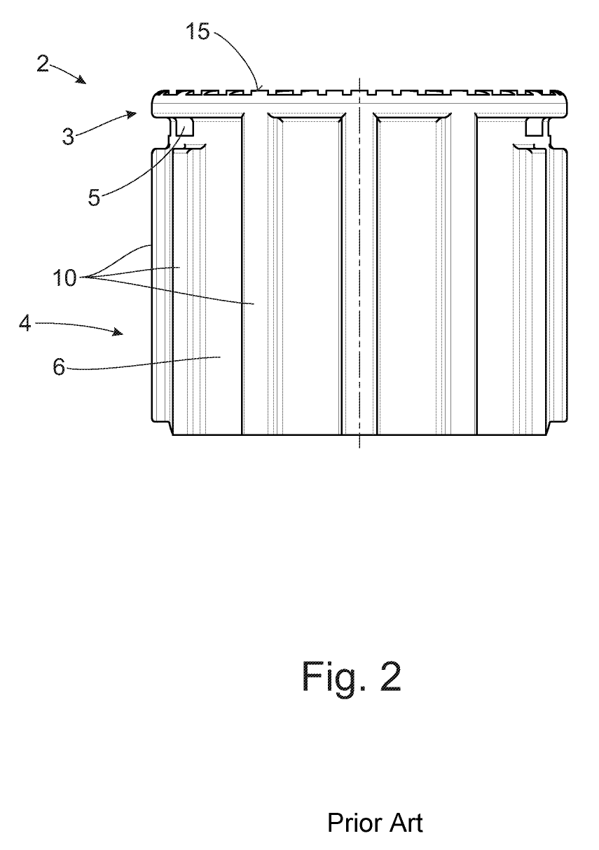

FIG. 2 shows an exemplary pressure stop cap 2 known from the prior art. In addition to the pressure stop cap 2 described above, there is also a plurality of ribs 10 which are formed at the upper surface 6 of the pressure stop cap 2 and extend along the entire length of the pressure stop cap 2 but at least up to the vent openings 5.

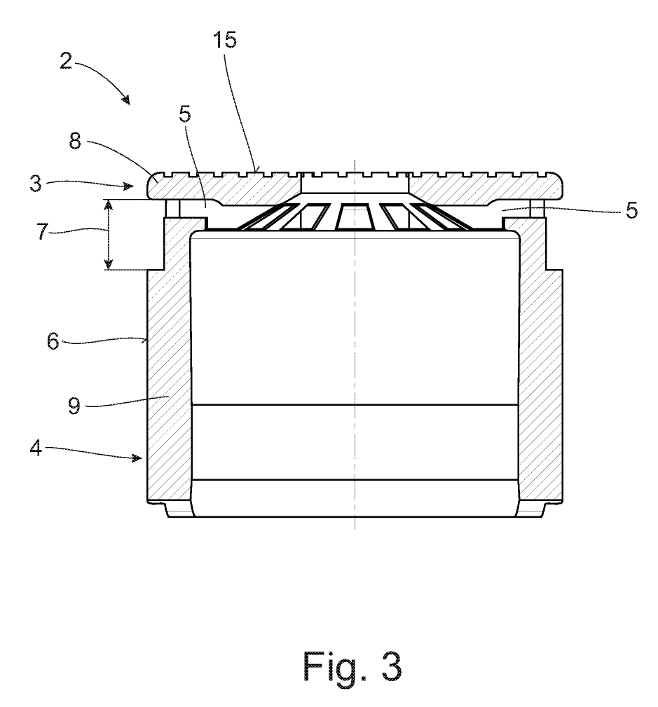

FIGS. 3, 4 and 5 each show a constructional embodiment of a pressure stop cap 2 according to the present invention comprising, in each instance, a groove-like circumferential recess 7 which is formed at the outer surface 6 of the pressure stop cap 2 and which divides the outer surface 6 of the pressure stop cap 2 axially into a first pressure stop cap portion 8 and a second pressure stop cap portion 9.

The first pressure stop cap portion 8 is formed in the area of the end portion 3 axially adjacent to the one axial side of the circumferential recess 7, and the second pressure stop cap portion 9 extends axially proceeding from the opposite end of the circumferential recess 7.

The respective cross section of each pressure stop cap portion 8, 9 is larger than the cross section of the pressure stop cap 2 in the area of the circumferential recess 7.

Depending on requirements, it can be provided that the cross sections of the two pressure stop cap portions 8, 9 are identical or differ.

FIG. 3 shows a constructional embodiment of the pressure stop cap 2 according to the invention in which the circumferential groove-like recess 7 is arranged in the area of the vent openings 5. The vent openings can be formed in the edge area of the circumferential recess 7 as is shown in FIG. 3 or at a distance from the edge area up to the axial mid-extension of the circumferential recess area 7.

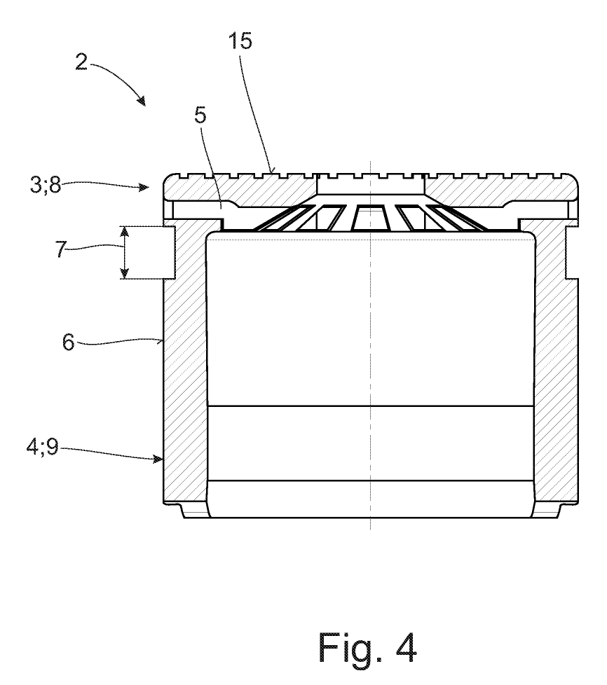

The alternative constructional embodiment shown in FIG. 4 provides that the circumferential groove-like recess 7 is arranged axially below the area of the vent opening 5 such that the vent opening 5 extends radially through the pressure stop cap 2 in the area of the first pressure stop cap portion 8.

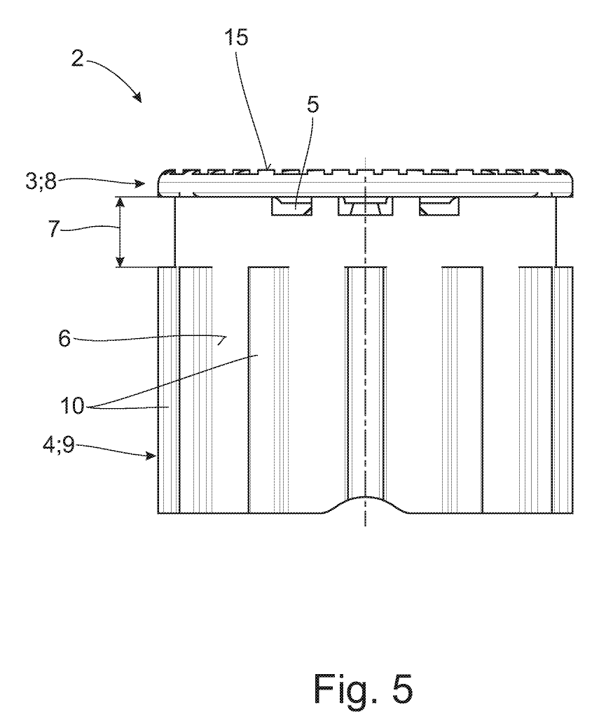

According to the constructional embodiment shown in FIG. 5, the pressure stop cap 2 comprises a plurality of axially extending ribs 10 arranged at the outer pressure stop cap surface 6. In this case, the circumferential recess 7 is arranged such that it axially limits the axial extension of the ribs 10. Accordingly, ribs 10 extend axially up to the circumferential recess 7 on the one side and up to the end of the pressure stop cap 2 on the other side.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A pressure stop cap for a motor vehicle vibration damper comprising:
a disk-shaped end portion in an end area of the pressure stop cap forming a rebound surface for an impact absorber;
a tubular portion extending axially from the disk-shaped end portion;
at least one vent opening arranged adjacent to the end portion in the end area and extending radially through the tubular portion;
a groove-like circumferential recess formed at an outer surface of the pressure stop cap and dividing the outer surface axially into a first pressure stop cap portion and a second pressure stop portion, wherein the first pressure stop cap portion is formed in the area of the end portion;
wherein the cross section of the first pressure stop cap portion is larger than the cross section of the pressure stop cap in the area of the circumferential recess, and wherein the cross section of the second pressure stop cap portion is larger than the cross section of the pressure stop cap in the area of the circumferential recess.

2. The pressure stop cap according to claim 1, wherein the circumferential groove-like recess is arranged in an area of the vent opening.

3. The pressure stop cap according to claim 1, wherein the circumferential groove-like recess is arranged axially below an area of the vent opening.

4. The pressure stop cap according to claim 1, additionally comprising a plurality of axially extending ribs arranged at the outer pressure stop cap surface, wherein the axial extension of the ribs is axially limited through the circumferential recess on one side and through the length of the pressure stop cap on another side.
